(19) United States
(12) Patent Application Publication
(10) Pub. No.: US 2008/0151199 A1
(43) Pub. Date: Jun. 26, 2008

(54) Projection display system of quasi-axial optical imagery

(76) Inventors: Bao-gang Wu, Beijing (CN); Ji-ning Wu, Beijing (CN); Lu Cheng, Beijing (CN); Jian-mi Gao, Beijing (CN); Shuai Zeng, Beijing (CN); Hong-shou Yu, Beijing (CN); Yu-kuan Li, Beijing (CN); Wei Zhang, Beijing (CN); Zhi-jian Zhang, Beijing (CN); Shou-ying Liu, Beijing (CN); Qin Zhao, Beijing (CN)

Correspondence Address: Yingsheng Tung, 3901 Inverness Lane, Plano, TX, 75075, US

(21) Appl. No.: 11/644,395

(22) Filed: Dec. 21, 2006

(51) Int. Cl. G03B 21/20

(52) U.S. Cl. 353/102

(57) ABSTRACT

A quasi-axial optical imagery projection system is disclosed in this paper. The system includes optical imagery sets; each may be lenses, mirrors, or a combination of both. The system also has a light source close to an imager, which may be a planar mask with a pattern, a LCD imager, or other suitable imagers. The system also has a display screen. Both the imager and the display screen are set at acute angles with respect to an optical axis so that what is projected on the display screen is a magnified image of the imager by a magnification factor that has a transverse component and a longitudinal component. This quasi-axial projection system may be made thinner than other rear projection system of comparable screen size.

### BACKGROUND OF THE INVENTION

This Invention relates to a projection display system, and more particularly to a projection display system of quasi-axial optical imagery.

Recently, the traditional cathode-ray-tube (CRT) rear-projection TV sets are losing favor in the consumer market to large screen TV sets built with alternative technologies because for a similarly sized display the later are lighter in weight, have slimmer profile, and are more power efficient.

The non-traditional large-screen display systems generally may be categorized into two groups. The first group includes LCD panel TVs and plasma panel TVs, the second group includes rear-projection TVs (RPTVs).

Today's RPTV uses a microdisplay as imager and a projection system to provide high density content of 800 by 1000 lines per inch or higher and a magnification system that enlarges the image from a tiny light source. Three microdisplay technologies are available commercially today—LCDs, Texas Instruments' digital light processing (DLP), and liquid crystal on silicon (LCoS).

The RPTV directs the light from the light source via the imager to the display screen by way of an optical imaging set, which may include lenses, reflective mirrors. In today's RPTV, the display screen is perpendicular or close to perpendicular to the light impinging on it—a fact that makes the large screen RPTVs relatively thicker compared to a LCD panel or a plasma panel TV of comparable screen size.

### BRIEF SUMMARY OF THE INVENTION

Applicants recognize that one way to reduce the thickness of the profile of a RPTV is tilt the display screen away from being perpendicular to the impinging light. The invention-embodying examples described in this paper disclose methods and structures of such slim display systems of excellent, distortion free imagery.

One embodiment of this invention is an optical system for projection display with a large screen based on the quasi-axial imagery, where the screen and the impinging light form an acute angle.

Another embodiment discloses an optical display system that includes two optical imaging sets, where the screen and the impinging light form an acute angle. The sets may comprise lenses or reflective mirrors or a combination of lenses and mirrors.

In one embodiment, the first optical imaging set has a first optical center and a first focal length; the second optical imaging set has a second optical center and a second focal length, which is longer than the first focal length. The system also includes a light source, an imager and a display screen. The light source and the imager are near the first optical imaging set while the display screen is near the second optical imaging set. In this embodiment, the imager has a planar surface, which forms a first acute angle, preferably about 50 degrees or smaller with respect to an optical axis that passes the first focal center. The optical axis is defined in this paper as an geometrical line connecting the light source to a point on the display screen, preferably at the center of the display screen. The display screen in this embodiment forms a second acute angle, preferably about 10 degrees or smaller, with respect to the optical axis that passes the second focal center.

In a simple optical system, the optical axis may be a straight line; in a more complex system, the optical axis may be folded by optical devices such as prisms, mirrors, or the imagers; or it may be split by optical devices such as dichroic filters or mirrors, and therefore does not remain on a straight line.

The first and the second imaging sets in this embodiment are displaced by an optical distance approximately equal the sum of the focal lengths of the two optical imaging sets. When so spaced apart, the system—a co-focal system—magnifies the image of the imager by a magnification factor that is independent of the displacement of the imager relative to the optical imaging sets.

In a quasi-axial optical imagery system where the imager and the display screen each forms an acute angle with respect to the optical axis, the magnification factor of the displayed image comprises two components—a transverse component perpendicularly to the optical axis and a longitudinal component parallel to the optical axis. In this embodiment, the longitudinal component is approximate the square of the transverse component; i.e. it is approximately equal to the product of the transverse component multiplied by the transverse component, as will be explained in more detail later in this paper.

In another embodiment, the light source has a red component, a green component, and a blue component.

In another embodiment, the optical axis is folded by planar reflective mirrors.

In another embodiment, the display system includes dichroic mirrors and cholesterol liquid crystal plates.

In another embodiment, the display system includes Fresnel lenses and light compensators.

In another embodiment, the display system includes spherical mirrors and non-spherical mirror.

The projection system described in this paper may be adapted for either a front-projection system or a rear-projection system.

### BRIEF DESCRIPTION OF THE SEVERAL VIEWS OF THE DRAWINGS

FIG. 1 depicts an optical imagery system of known art.

FIG. 2 depicts an axial projection imagery system of known art.

FIG. 3 depicts a quasi-axial projection imagery system of this invention.

FIG. 4 depicts another quasi-axial projection imagery system of this invention.

FIG. 5 depicts another quasi-axial projection imagery system of this invention.

FIG. 6 depicts an alternative view of the system in FIG. 5.

### DETAILED DESCRIPTION OF THE INVENTION

FIG. 1 depicts a known axial optical imagery system. It has an optical set L and Z is its optical axis. The optical set L in FIG. 1 is a lens and it has a focal length f. An object represented by a line segment AB designated by a differential element du lies on the optical axis. The coordinate of A is A(u) and the coordinate of B is B(u+du). The image of the element AB formed is represented by another line segment A′B′, which also lies on the optical axis and is designated by a differential element du′. The coordinate of A′ is A′(u′), and that of B′ is B′(u′+du′).

In FIG. 1, the size of the object is du and the size of the image is du′. One may define M as the longitudinal magnification factor, which represents the ratio of the size of the image to that of the object in the direction parallel to the optical axis. If the image and the object have a component perpendicular to the optical axis, one may further define m as the transverse magnification factor, which is the ratio of the size of the image to that of the object in the direction perpendicular to the optical axis. From the fundamental imaging theory, the relationship of u, u′, and f may be expressed as

$$\begin{matrix}- \frac{1}{u} + \frac{1}{{u}^{′}} = \frac{1}{f} \\ \text{or} & ( 1 ) \\ {u}^{′} = \frac{uf}{u + f} . \\ \text{Thus} m \text{equals} & ( 2 ) \\ m = \frac{{u}^{′}}{u} = \frac{f}{u + f} , \text{and} \\ M \text{equals} & ( 3 ) \\ M = \frac{d {u}^{′}}{d u} = \frac{1}{{( u + f )}^{2}} [ f ( u + f ) - uf ] = \frac{{f}^{2}}{{( u + f )}^{2}} . & ( 4 )\end{matrix}$$

From equations (3) and (4), one can see that the longitudinal magnification factor equals the square of the transverse magnification factor, or

M=m². (5)

In equations (3) and (4), m and M are functions of u. In other words, the magnifications of the image depend on the position of the object with respect to the optical set L.

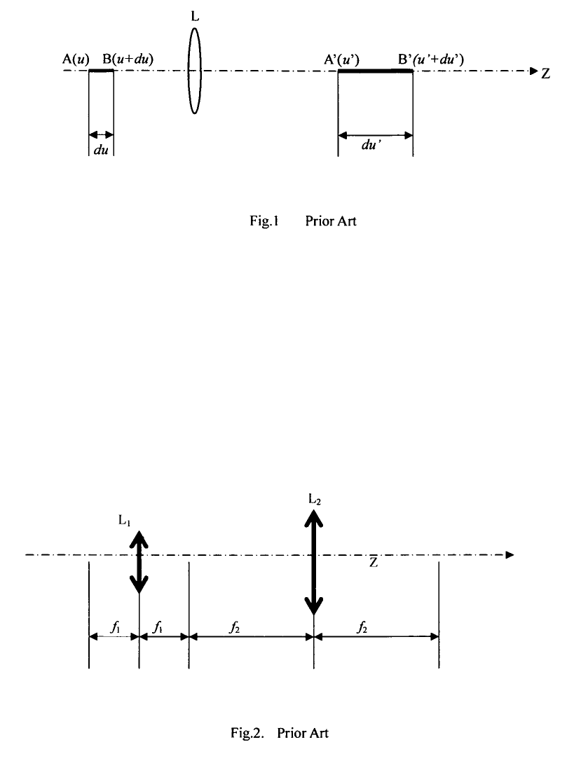

A more desirable system, especially one for consumer products, would be a one in which the magnification of the image is or is close to being independent of the precise location of the imager with respect to the optical set. Such a system may be realized with a co-focal system of two optical imaging sets as depicted in FIG. 2.

In FIG. 2, the first optical imaging set L₁ has a focal length of f₁ and the second optical imaging set L₂ has a second focal length of f₂. When the two optical imaging sets are spaced apart at an optical distance approaches the sum of f₁ and f₂, the magnification factor of the co-focal system becomes a function of only the focal lengths of the individual optical imaging sets L₁ and L₂—independent of the distance between the object and the combined optical imaging system, i.e.,

$$m = - \frac{{f}_{2}}{{f}_{1}} \\ M = {m}^{2} = {( \frac{{f}_{2}}{{f}_{1}} )}^{2} . \qquad ( 6 )$$

In such an axial-projection imagery system, the transverse magnification factor, m, and the longitudinal magnification factor, M, are independent of u.

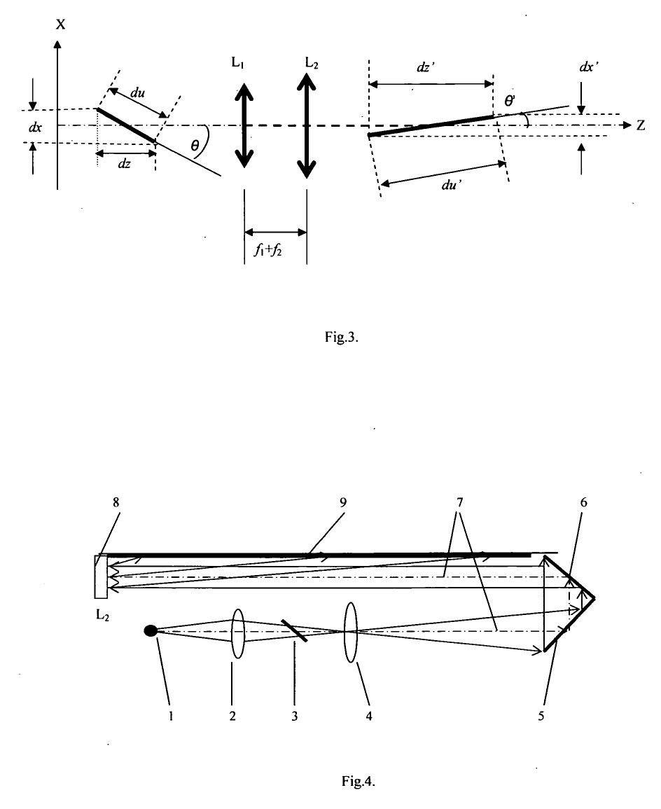

FIG. 3 depicts an embodiment of a quasi-axial projection imagery system of this invention. In this embodiment, the object is a planar imager and it is placed at an acute angle with respect to the optical axis Z, preferably less than 50 degrees, and is illuminated by a light source.

In FIG. 3, du represents an element of the object, and du′ represents the formed image of the element. The acute angle between the object and the optical axis is θ, which is preferably less than 50 degrees; and the acute angle between the image and the optical axis is θ′, which is preferably less than 10 degrees.

The magnification factor is defined as

M′=du′/du. (7)

The element du has a longitudinal component dz and a transverse component dx such that du=\sqrt{dx²+dz²}; the element du′ has a longitudinal component dz′ and a transverse component dx′ such that du′=\sqrt{dx′²+dz′²}, dx=dz tan θ, dx′=dz′ tan θ′, dx′=mdx and dz′=Mdz.

Substituting these equations into Eq. (7) one gets

$${M}^{′} = \frac{d {u}^{′}}{d u} = \frac{\sqrt{{m}^{2} d {x}^{2} + {M}^{2} d {z}^{2}}}{\sqrt{d {x}^{2} + d {z}^{2}}} . \qquad ( 8 )$$

Substituting mdx=Mdz tan θ′ and m tan θ=M tan θ′, Eq. (8) becomes

$${M}^{′} [ \frac{\sqrt{1 + \frac{1}{{m}^{2}} {tan}^{2} θ}}{\sqrt{1 + {tan}^{2} θ}} ] {m}^{2} = {Cm}^{2} . \qquad ( 9 )$$

From Eq. (9) one can see that the magnification factor of this quasi-axial imagery system is related to that of the axial imagery by a factor C, which is

$$C = \frac{\sqrt{1 + \frac{1}{{m}^{2}} {tan}^{2} θ}}{\sqrt{1 + {tan}^{2} θ}} . \qquad ( 10 )$$

In a system having two optical imaging sets of focal length f₁ and f₂, one can achieve a desired magnification factor M′ and the desired system profile by setting the display angle imager angle θ and the display screen angle θ″ with respect to the optical axis according to the following relationship:

$${θ}^{′} = arctan ( \frac{f 1}{f 2} tan θ ) . \qquad ( 11 )$$

In contrast, the current projection display technologies, in which the imager and the display screen or both are or are close to being perpendicular to the optical axis, put sever limitation on both the distortion of the displayed image and the bulkiness of the display system so compromise in system performance is often unavoidable.

The quasi-axial optical imagery projection display system disclosed in this paper, on the other hand, with both the imager and the display screen tilt so each makes an acute angle with respect to the optical axis, substantially removes this problem. In this system, the tilting of the display screen allows the thickness of the projection system to slim down and it is only limited by the intensity of the light source. The image distortion is also easily controlled by controlling the tilting angles of the imager and the display screen according to the desired system magnification factor M′.

The quasi-axial optical imagery projection display system has at least three advantages over the current projection display systems. First, because both the imager and especially the display screen are tilted with respect to the optical axis, it enables significant reduction in the system thickness compared to a current system in which the screen are or are close to being perpendicular to the optical axis. Second, because the quasi-axial optical imagery projection display system has longitudinal magnification in addition to transverse magnification, while current systems only has transverse magnification, the quasi-axial system offers system flexibility in choosing an imager that is most suitable for a specific application. For example, in certain applications, one can use an imager such as a thin-film-transistor (TFT) panel with relatively large area-per-pixel, which can be made with matured and cost effective manufacturing method in order to reduce the demand for high light-source intensity. Consequently, the system can be made with a light source of lesser intensity and with the associated benefits of being more radiation proof, and the temperature resistance. Third, the axial-imagery system of this Invention is simple to construct, easy to manufacture more cost effectively.

FIG. 4 depicts another embodiment of the invention. The system has a light source 1, which may be an ultra-high-performance (UHP) high-intensity mercury lamp. Other light sources such as high intensity LEDs may also be used. The source is placed at the objective focus of a Fresnel Lens 2, which condenses and collimates the light from the source 1 and illuminates the imager 3. The Fresnel lens 2 has an outer dimension of 200 mm by 180 mm and its focal length is 130 mm. The distance between lens 2 and the first imaging set 4 is 260 mm.

Imager 3 in this embodiment is a planar chromium glass mask with a checker-board pattern, with a dimension of 166 mm by 13.375 mm. The imager is set at an angle of 29.21 degrees with respect to the optical axis 7. In order to project square pixels on the display screen, the longitudinal to transverse ratio of pixels on the imager is about 8:1. In this embodiment the size of a pixel in the imager is 0.8 mm by 0.1 mm.

Imager 3 is placed at the outer side of the front focus of the first imaging set 4, which consists of seven individual lenses. The parameters of the lenses are listed below. The first plane mirror 5 and the second plane mirror 6 are set at 45° with respect to the optical axis. The mirrors fold the optical axis and the light path to reduce further the thickness of the system.

The second imaging set 8 is a spherical mirror with a radius about 2468 mm. It is set at 5 degrees offset from perpendicular to the optical axis. The center of curvature of mirror 8 coincides with the back focus of imaging set 4. The image reflected from the second imaging set 8 is displayed on screen 9. The distance between the center point of the surface of the last lens of the first imaging set 4 and the central point of the second imaging set 8 is about 1296 mm.

Pertinent data of the optical imaging system of this embodiment as produced by the optical system software ZEMAX are listed below. Person skilled in the art of projection display should be familiar with this software and the significance of the parameter list.

| Surf Type | Radius | Thickness | Glass | Diameter | Conic |
|---|---|---|---|---|---|
| OBJ TILTSURF | 84.00205 | | | 126.0992 | — |
| 1 STANDARD | Infinity | 0 | | 67.077 | 0 |
| 2 EVENASPH | −131.4671 | 26 | ZF2 | 95 | 0 |
| 3 EVENASPH | −301.552 | 1.7 | | 95 | 0 |
| 4 EVENASPH | 62.54333 | 14 | K9 | 89 | 0 |
| 5 EVENASPH | 126.3622 | 1 | | 89 | 0 |
| 6 EVENASPH | 66.44446 | 20 | ZK11 | 82 | 0 |
| 7 STANDARD | 134.84 | 8 | ZF7 | 82 | 0 |
| 8 EVENASPH | 78.3394 | 11.6 | | 25.37258 | 0 |
| STO STANDARD | Infinity | 3 | | 16.54242 | 0 |
| 10 EVENASPH | −332.2905 | 35 | F2 | 20.20198 | 0 |
| 11 STANDARD | 255.7889 | 14 | ZK11 | 75 | 0 |
| 12 EVENASPH | −70.01809 | 15.75 | | 75 | 0 |
| 13 EVENASPH | −68.20695 | 41 | ZF2 | 80 | 0 |
| 14 EVENASPH | −110.4211 | 1296.3 | | 120 | 0 |
| 15 COORDBRK | — | 0 | | — | — |
| 16 STANDARD | −2468.2 | −464.8879 | MIR- | 1097.498 | 0 |
| | | | ROR | | |
| 17 COORDBRK | — | −30 | | — | — |
| 18 COORDBRK | — | 0 | | — | — |
| IMA STANDARD | Infinity | | | 1219.229 | 0 |

### Surface Data Detail:

| Surface OBJ | TILTSURF |
|---|---|
| X Tangent | 0 |
| Y Tangent | −1.7884305 |
| Aperture | Rectangular Aperture |
| X Half Width | 63.04958 |
| Y Half Width | 3 |
| Surface 1 | STANDARD |
| Surface 2 | EVENASPH |
| Coeff on r 2 | 0 |
| Coeff on r 4 | 9.98E−07 |
| Coeff on r 6 | 0 |
| Coeff on r 8 | 0 |
| Coeff on r 10 | 0 |
| Coeff on r 12 | 0 |
| Coeff on r 14 | 0 |
| Coeff on r 16 | 0 |
| Aperture | Floating Aperture |
| Maximum Radius | 47.5 |
| Surface 3 | EVENASPH |
| Coeff on r 2 | 0 |
| Coeff on r 4 | −3.25E−08 |
| Coeff on r 6 | 0 |
| Coeff on r 8 | 0 |
| Coeff on r 10 | 0 |
| Coeff on r 12 | 0 |
| Coeff on r 14 | 0 |
| Coeff on r 16 | 0 |
| Aperture | Floating Aperture |
| Maximum Radius | 47.5 |
| Surface 4 | EVENASPH |
| Coeff on r 2 | 0 |
| Coeff on r 4 | −2.81E−06 |
| Coeff on r 6 | 0 |
| Coeff on r 8 | 0 |
| Coeff on r 10 | 0 |
| Coeff on r 12 | 0 |
| Coeff on r 14 | 0 |
| Coeff on r 16 | 0 |
| Aperture | Floating Aperture |
| Maximum Radius | 44.5 |
| Surface 5 | EVENASPH |
| Coeff on r 2 | 0 |
| Coeff on r 4 | 7.75E−07 |
| Coeff on r 6 | 0 |
| Coeff on r 8 | 0 |
| Coeff on r 10 | 0 |
| Coeff on r 12 | 0 |
| Coeff on r 14 | 0 |
| Coeff on r 16 | 0 |
| Aperture | Floating Aperture |
| Maximum Radius | 44.5 |
| Surface 6 | EVENASPH |
| Coeff on r 2 | 0 |
| Coeff on r 4 | 2.46E−06 |
| Coeff on r 6 | 0 |
| Coeff on r 8 | 0 |
| Coeff on r 10 | 0 |
| Coeff on r 12 | 0 |
| Coeff on r 14 | 0 |
| Coeff on r 16 | 0 |
| Aperture | Floating Aperture |
| Maximum Radius | 41 |
| Surface 7 | STANDARD |
| Aperture | Floating Aperture |
| Maximum Radius | 41 |
| Surface 8 | EVENASPH |
| Coeff on r 2 | 0 |
| Coeff on r 4 | 2.17E−06 |
| Coeff on r 6 | 0 |
| Coeff on r 8 | 0 |
| Coeff on r 10 | 0 |
| Coeff on r 12 | 0 |
| Coeff on r 14 | 0 |
| Coeff on r 16 | 0 |
| Surface STO | STANDARD |
| Surface 10 | EVENASPH |
| Coeff on r 4 | 8.79E−07 |
| Coeff on r 6 | 0 |
| Coeff on r 8 | 0 |
| Coeff on r 10 | 0 |
| Coeff on r 12 | 0 |
| Coeff on r 14 | 0 |
| Coeff on r 16 | 0 |
| Surface 11 | STANDARD |
| Aperture | Floating Aperture |
| Maximum Radius | 37.5 |
| Surface 12 | EVENASPH |
| Coeff on r 2 | 0 |
| Coeff on r 4 | 8.34E−07 |
| Coeff on r 6 | 0 |
| Coeff on r 8 | 0 |
| Coeff on r 10 | 0 |
| Coeff on r 12 | 0 |
| Coeff on r 14 | 0 |
| Coeff on r 16 | 0 |
| Aperture | Floating Aperture |
| Maximum Radius | 37.5 |
| Surface 13 | EVENASPH |
| Coeff on r 2 | 0 |
| Coeff on r 4 | 1.15E−06 |
| Coeff on r 6 | 0 |
| Coeff on r 8 | 0 |
| Coeff on r 10 | 0 |
| Coeff on r 12 | 0 |
| Coeff on r 14 | 0 |
| Coeff on r 16 | 0 |
| Aperture | Floating Aperture |
| Maximum Radius | 40 |
| Surface 14 | EVENASPH |
| Coeff on r 2 | 0 |
| Coeff on r 4 | 2.23E−07 |
| Coeff on r 6 | 0 |
| Coeff on r 8 | 0 |
| Coeff on r 10 | 0 |
| Coeff on r 12 | 0 |
| Coeff on r 14 | 0 |
| Coeff on r 16 | 0 |
| Aperture | Floating Aperture |
| Maximum Radius | 60 |
| Surface 15 | COORDBRK |
| Decenter X | 0 |
| Decenter Y | 3 |
| Tilt About X | −2.5 |
| Tilt About Y | 0 |
| Tilt About Z | 0 |
| Order | Decenter then tilt |
| Surface 16 | STANDARD |
| Aperture | Rectangular Aperture |
| X Half Width | 550 |
| Y Half Width | 40 |
| Surface 17 | COORDBRK |
| Decenter X | 0 |
| Decenter Y | −3 |
| Tilt About X | 2.5 |
| Tilt About Y | 0 |
| Tilt About Z | 0 |
| Order | Decenter then tilt |
| Surface 18 | COORDBRK |
| Decenter X | 0 |
| Decenter Y | −20 |
| Tilt About X | 89.02913 |
| Tilt About Y | 0 |
| Tilt About Z | 0 |
| Order | Decenter then tilt |
| Surface IMA | STANDARD |
| Aperture | Rectangular Aperture |
| X Half Width | 530 |
| Y Half Width | 370 |

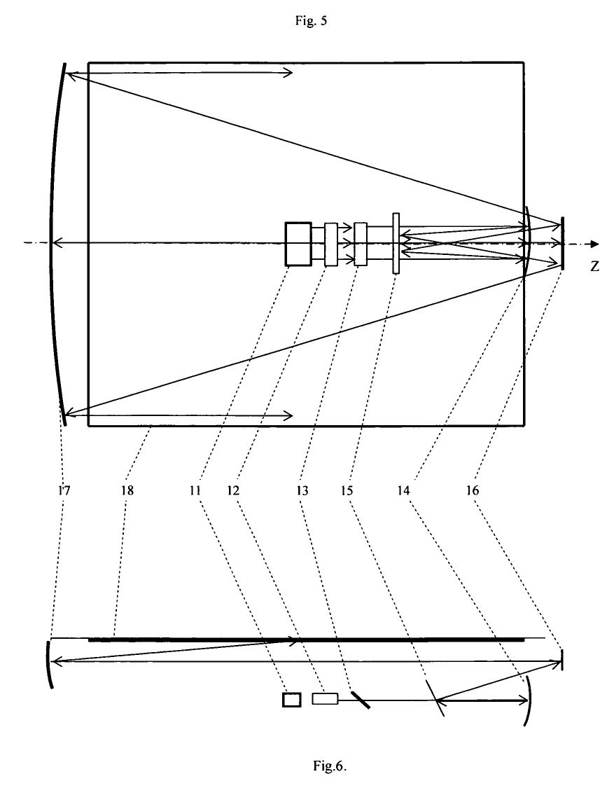

FIG. 5 and FIG. 6 depict two orthogonal perspectives of another embodiment of this invention. In this embodiment, the light source 11 is an array of 10 sets of LED's spaced apart by 20 mm. Each LED set has a red, a green, and a blue LED, and a lens 12 of focal length about 20 mm and an aperture of 20 mm by 20 mm.

In this embodiment, the imager 13 is a color film. The longitudinal to transverse ratio of the imager is 3.61:1.05 and the resulting image displayed on the screen is square. Imager 13 is set at an angle of 18 degrees with respect to the optical axis.

The first imaging set is a non-spherical mirror 14 with a radius of about 1928.825 mm to 1300.001 mm. Its focal plane is perpendicular to the optical axis Z.

Element 15 in this embodiment is a planar mirror set comprises 3 pieces of cholesterol liquid crystal, of which the central wavelengths match the central wavelengths of the three colored LED's. The planar mirror set folds the light path to reduce the system thickness. The surface of the planar mirror is set at 86 degrees with respect to the optical axis; and at a distance 660 mm from the non-spherical Mirror 14.

Mirror 16 is another planar mirror of high reflective power with a reflectivity higher than 75%. Mirror 16 is set at a distance about 650 mm from the planar mirror 15.

The second imaging set 17 is also a non-spherical mirror of radius between 4696.264 mm and 4698.281 mm. The second focus of first imaging set 14 coincides with the first focus of the second imaging set 17.

Element 18 is a display screen. It is set at 4.6 degrees with respect to the optical axis.

Pertinent data of the optical imaging system of this embodiment as produced by the software ZEMAX are listed below. Person skilled in the art of projection display should be familiar with this software and the significance of the parameter list.

### Surface Data Summary:

| Surf Type | Radius | Thickness | Glass | Diameter | Conic |
|---|---|---|---|---|---|
| OBJ TILTSURF | — | −742.7317 | | 117.7455 | |
| 1 COORDBRK | — | 0 | | — | — |
| STO TOROIDAL | 1298.825 | 0 | MIR- | 216.8664 | 0 |
| | | | ROR | | |
| 3 COORDBRK | — | 660 | | — | — |
| 4 COORDBRK | — | 0 | | — | — |
| 5 STANDARD | Infinity | 0 | MIR- | 81.31919 | 0 |
| | | | ROR | | |
| 6 COORDBRK | — | −650 | | — | — |
| 7 COORDBRK | — | 0 | | — | — |
| 8 STANDARD | Infinity | 0 | MIR- | 196.5455 | 0 |
| | | | ROR | | |
| 9 COORDBRK | — | 1702.304 | | — | — |
| 10 COORDBRK | — | 0 | | — | — |
| 11 TOROIDAL | −4696.264 | 0 | MIR- | 497.6951 | 0 |
| | | | ROR | | |
| 12 COORDBRK | — | 0 | | — | — |
| 13 COORDBRK | — | 0 | | — | — |
| IMA TOROIDAL | Infinity | | BK7 | 4196.618 | 0 |

### Surface Data Detail:

| Surface OBJ | TILTSURF |
|---|---|
| X Tangent | 0 |
| Y Tangent | 3.4335624 |
| Aperture | Rectangular Aperture |
| X Half Width | 55.35 |
| Y Half Width | 21 |
| Surface 1 | COORDBRK |
| Decenter X | 0 |
| Decenter Y | 0 |
| Tilt About X | 0 |
| Tilt About Y | 0 |
| Tilt About Z | 0 |
| Order | Decenter then tilt |
| Surface STO | TOROIDAL |
| Rad of rev. | 1300.001 |
| Coeff on y\hat{ }2 | 0 |
| Coeff on y\hat{ }4 | 0 |
| Coeff on y\hat{ }6 | 0 |
| Coeff on y\hat{ }8 | 0 |
| Coeff on y\hat{ }10 | 0 |
| Coeff on y\hat{ }12 | 0 |
| Coeff on y\hat{ }14 | 0 |
| Aperture | Rectangular Aperture |
| X Half Width | 90 |
| Y Half Width | 90 |
| Surface 3 | COORDBRK |
| Decenter X | 0 |
| Decenter Y | 0 |
| Tilt About X | 0 |
| Tilt About Y | 0 |
| Tilt About Z | 0 |
| Order | Decenter then tilt |
| Surface 4 | COORDBRK |
| Decenter X | 0 |
| Decenter Y | 0 |
| Tilt About X | −4 |
| Tilt About Y | 0 |
| Tilt About Z | 0 |
| Order | Decenter then tilt |
| Surface 5 | STANDARD |
| Aperture | Floating Aperture |
| Maximum Radius | 40.6596 |
| Surface 6 | COORDBRK |
| Decenter X | 0 |
| Decenter Y | 0 |
| Tilt About X | −4 |
| Tilt About Y | 0 |
| Tilt About Z | 0 |
| Order | Decenter then tilt |
| Surface 7 | COORDBRK |
| Decenter X | 0 |
| Decenter Y | 0 |
| Tilt About X | 4 |
| Tilt About Y | 0 |
| Tilt About Z | 0 |
| Order | Decenter then tilt |
| Surface 8 | STANDARD |
| Aperture | Floating Aperture |
| Maximum Radius | 98.27274 |
| Surface 9 | COORDBRK |
| Decenter X | 0 |
| Decenter Y | 0 |
| Tilt About X | 4 |
| Tilt About Y | 0 |
| Tilt About Z | 0 |
| Order | Decenter then tilt |
| Surface 10 | COORDBRK |
| Decenter X | 0 |
| Decenter Y | 0 |
| Tilt About X | −2.3245653 |
| Tilt About Y | 0 |
| Tilt About Z | 0 |
| Order | Decenter then tilt |
| Surface 11 | TOROIDAL |
| Rad of rev. | −4698.2813 |
| Coeff on y\hat{ }2 | 0 |
| Coeff on y\hat{ }4 | 0 |
| Coeff on y\hat{ }6 | 0 |
| Coeff on y\hat{ }8 | 0 |
| Coeff on y\hat{ }10 | 0 |
| Coeff on y\hat{ }12 | 0 |
| Coeff on y\hat{ }14 | 0 |
| Aperture | Rectangular Aperture |
| X Half Width | 250 |
| Y Half Width | 120 |
| Surface 12 | COORDBRK |
| Decenter X | 0 |
| Decenter Y | 0 |
| Tilt About X | 2.3245653 |
| Tilt About Y | 0 |
| Tilt About Z | 0 |
| Order | Decenter then tilt |
| Surface 13 | COORDBRK |
| Decenter X | 0 |
| Decenter Y | −90 |
| Tilt About X | 89.952927 |
| Tilt About Y | 0 |
| Tilt About Z | 0 |
| Order | Decenter then tilt |
| Surface IMA | TOROIDAL |
| Rad of rev. | 14706.845 |
| Coeff on y\hat{ }2 | 0 |
| Coeff on y\hat{ }4 | 0 |
| Coeff on y\hat{ }6 | 0 |
| Coeff on y\hat{ }8 | 0 |
| Coeff on y\hat{ }10 | 0 |
| Coeff on y\hat{ }12 | 0 |
| Coeff on y\hat{ }14 | 0 |
| Aperture | Floating Aperture |
| Maximum Radius | 2098.309 |

Applicants have given a detailed description on the implementations of preferred embodiments of this invention. Persons skilled in the art of projection display may make changes and modifications based on this description. For example, ultra high performance (UHP) high intensity discharge lamp, or a semiconductor laser may be used as alternative light source; LCD, LCoS, or other digital light processor may be used as alternative imager. But these changes and modifications do not separate themselves from the core spirit of this invention, and therefore are within the range of protection, which is only limited by the appending claims.

What is claimed is:

1. An optical projection display system, comprising:
a. a first optical imaging set having a first focal length, a first optical center, and a first focal point, a first segment of a optical axis connecting the first optical center and the first focal point;
b. a second optical imaging set having a second focal length longer than the first focal length, a second optical center and a second focal point, a second segment of a optical axis connecting the second optical center and the second focal point, the second optical center and the first optical center being separated by an optical distance along the optical axis;
c. a light source near the first optical center;
d. an imager having an planar area, forming a first angle not greater than 50 degrees with respect to the optical axis; and
e. a display screen forming a second angle not greater than 10 degrees with respect to the optical axis.

2. The optical projection display system of claim 1, in which the optical distance is close to the sum of the first focal length and the second focal length.

3. The optical projection display system of claim 1, in which the combination of the first and the second optical set is operable to magnify an optical image of the imager by a magnifying factor and project the magnified optical image on the display screen.

4. The optical projection display system of claim 3, in which the magnification factor includes a transverse magnification factor and a longitudinal magnification factor.

5. The optical projection display system of claim 4, in which the transverse magnification factor is approximately equal to the product of the longitudinal magnification factor times the longitudinal magnification factor.

6. The optical projection display system of claim 1, in which the first angle is smaller than 10 degrees.

7. The optical projection display system of claim 1, in which the light source is a UHP, a LED, or a semiconductor laser.

8. The optical projection display system of claim 1, in which the light source has a red component, a green component, and a blue component.

9. The optical projection display system of claim 1, further comprising lens, mirror, compensator, or combination thereof.

10. The optical projection display system of claim 1, in which the first optical imaging set comprises lenses and the second optical imaging set comprises spherical mirrors.

11. The optical projection display system of claim 10, in which the first optical imaging set consists of 7 lenses and the second optical imaging set consists of one spherical mirror.

12. The optical projection display system of claim 1, further comprising reflection mirrors.

13. The optical projection display system of claim 1, in which the first optical imaging set consists of one non-spherical mirror and the second optical imaging set consists of one non-spherical mirror.

14. The optical projection display system of claim 13, further comprising a first plane mirror and a second plane mirror between the non-spherical mirrors.

15. The optical projection display system of claim 14, in which the first plane mirror comprises three cholesterol liquid crystal plates.

16. The optical projection display system of claim 1, in which the imager includes a TFT LCD panel.

17. A method of making an optical projection display system, comprising:
a. providing a first optical imaging set having a first focal length, a first optical center, and a first focal point, a first segment of a optical axis connecting the first optical center and the first focal point;
b. providing a second optical imaging set having a second focal length longer than the first focal length, a second optical center and a second focal point, a second segment of a optical axis connecting the second optical center and the second focal point,
c. placing the second optical imaging set such that the center and the first optical center are separated by an optical distance along the optical axis;
d. placing a light source near the first optical center;
e. placing an imager having an planar area near the light source, the imager forming a first angle not greater than 50 degrees with respect to the optical axis; and
f. placing a display screen near the second optical image set forming a second angle not greater than 10 degrees with respect to the optical axis.
g. The optical projection display system of claim 10, in which the first optical imaging set consists of 7 lenses and the second optical imaging set consists of one spherical mirror.

18. The method of claim 17, in which the optical distance is close to the sum of the first focal length and the second focal length.

19. The method of claim 17, in which the first optical imaging set consists of 7 lenses and the second optical imaging set consists of one spherical mirror.

20. The method of claim 17, in which the first angle is smaller than 10 degrees.
